(19) United States
(12) Patent Application Publication
(10) Pub. No.: US 2007/0291853 A1
(43) Pub. Date: Dec. 20, 2007

(54) Method and apparatus for transmitting/receiving uncompressed data

(75) Inventors: Seong-soo Kim, Seoul (KR); Ki-bo Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/727,140

(22) Filed: Mar. 23, 2007

Related U.S. Application Data
(60) Provisional application No. 60/814,588, filed on Jun. 19, 2006.

(30) Foreign Application Priority Data
Sep. 15, 2006 (KR) 10-2006-0089799

(51) Int. Cl. H04N 7/64

(52) U.S. Cl. 375/240.27; 375/E07.279

(57) ABSTRACT

Apparatuses and methods are provided for transmitting/receiving uncompressed data in which, when the uncompressed data is transmitted or received over a wireless network, different code rates are applied to the data according to the significance of bits or bit groups included in the data. An apparatus for transmitting uncompressed data includes: a mode determining unit which determines a mode corresponding to a condition; a grouping unit which classifies bits of each pixel included in the uncompressed data into at least two groups according to the mode; an error correction coding unit which performs error correction coding on each of the groups at a code rate corresponding to the mode; and an RF processing unit which transmits the coded uncompressed data.

### CROSS REFERENCE TO RELATED APPLICATION

This application claims priority from Korean Patent Application No. 10-2006-89799 filed on Sep. 15, 2006 in the Korean Intellectual Property Office, and U.S. Provisional Patent Application No. 60/814,588 filed on Jun. 19, 2006 in the United States Patent and Trademark Office, the disclosures of which are incorporated herein by reference in their entirety.

### BACKGROUND OF THE INVENTION

1. Field

Apparatuses and methods consistent with the present invention relate to transmitting/receiving uncompressed data, and more particularly, to transmitting/receiving uncompressed data in which different code rates are applied to according to significance of bits or bit groups included in the uncompressed data when the uncompressed data is transmitted/received over a wireless network.

2. Description of the Related Art

In related art wireless networks, demand for the transmission of mass multimedia data has increased, and studies for an effective transmission method in a wireless network environment have been demanded. In addition, a necessity for wireless transmission of a high-quality video, such as a digital video disk (DVD) video, a high definition television (HDTV) video, among various home devices has increased in the related art.

An IEEE 802.15.3c task group is considering a technical standard for transmitting mass data over a wireless home network. This standard, called millimeter wave (mmWave), uses an electrical wave having a physical wavelength of several millimeters for the sake of the transmission of the mass data (that is, an electrical wave having a frequency of 30 GHz to 300 GHz). In the related art, this frequency band is an unlicensed band and is limitedly used for, for example, communication carriers, radio astronomy, or vehicle anti-collision.

FIG. 1 is a diagram illustrating a comparison between the frequency band of the IEEE 802.11 standard and the frequency band of the mmWave. In the IEEE 802.11b standard or the IEEE 802.11g standard, a carrier frequency is 2.4 GHz, and a channel bandwidth is about 20 MHz. Further, in the IEEE 802.11a standard or the IEEE 802.11n standard, a carrier frequency is 5 GHz, and a channel bandwidth is about 20 MHz. In contrast, in the mmWave, a carrier frequency of 60 GHz is used, and a channel bandwidth is in the range of about 0.5 to 2.5 GHz. Accordingly, mmWave has a considerably higher carrier frequency and a considerably larger channel bandwidth than the existing IEEE 802.11 standards. As such, if a high-frequency signal having a wavelength in millimeters (millimeter wave) is used, a high transmission rate of several Gbps can be obtained, and the size of an antenna can be set to be smaller than 1.5 mm. Therefore, a single chip including the antenna can be implemented. In addition, since an attenuation ratio is high in the air, the interference between apparatuses can be reduced.

In recent years, a technique for transmitting uncompressed audio or video data (hereinafter, referred to as uncompressed data) between wireless apparatuses using the millimeter wave having a large bandwidth has been studied. Compressed data is compressed with a partial loss through processes such as motion compensation, discrete cosine transform (DCT) conversion, quantization, and variable length coding, such that portions of the data insensitive to the sense of sight or the sense of hearing of human beings are eliminated. In contrast, uncompressed data includes digital values (for example, R, G, and B components) representing pixel components.

Therefore, there is no difference in significance between bits included in the compressed data, but there is a difference in significance between bits included in the uncompressed data. For example, as shown in FIG. 2, in case of an eight-bit image, one pixel component is represented by eight bits. Among the eight bits, a bit representing the highest order (a bit at the highest level) is the most significant bit (MSB), and a bit representing the lowest order (a bit at the lowest level) is the least significant bit (LSB). That is, in one-byte data composed of eight bits, the bits have different significances in restoring a video signal or an audio signal.

When an error occurs in a bit having high significance during transmission, it is possible to detect the error easier than when the error occurs in a bit having low significance. Therefore, it is necessary to protect bit data having high significance such that no error occurs in the bit data during wireless transmission, as compared to bit data having low significance. A method of correcting errors of all bits to be transmitted at the same code rate, which is a related art transmission method, has been used in the IEEE 802.11 standard.

FIG. 3 is a diagram illustrating the structure of a PHY protocol data (PPDU) of the IEEE 802.11a standard. A PPDU 30 includes a preamble, a signal field, and a data field. The preamble is a signal used for synchronizing a PHY layer and estimating a channel, and includes a plurality of short training signals and a plurality of long training signals. The signal field includes a RATE field indicating a transmission rate and a LENGTH field indicating the length of the PPDU. In general, the signal field is encoded by one symbol. The data field is composed of PSDU, a tail bit, and a pad bit, and data to be transmitted actually is included in PSDU.

Data recorded on PSDU is composed of codes encoded by a convolution encoder. There is no difference in significance between bits constituting data, such as uncompressed data, but the data is encoded by the same error correction coding process. Therefore, the same error correcting capability is applied to the bits.

The related method is effective in transmitting general data. However, when there is a difference in significance between portions of data to be transmitted, a more robust error correction coding process should be performed on bits having higher significance to reduce the probability that an error occurs in the bits.

The transmitter performs an error correction coding process on data to prevent the occurrence of an error. Even when an error occurs in the coded data, the coded data having the error can be restored in a predetermined range in which the error can be corrected. There are various error correction coding processes, and the error correction coding processes have different capabilities to correct errors according to error correction coding algorithms. The performances of the error correction coding algorithms depend on a code rate.

As the code rate becomes higher, the transmission efficiency of data becomes higher, but capability to correct errors is lowered. In contrast, as the code rate becomes lower, the transmission efficiency of data becomes lower, but the capability to correct errors is raised. As described above, in the uncompressed data, bits constituting the uncompressed data have difference significances, unlike the compressed data. Therefore, it is necessary to protect high-level bits having high significance such that no error occurs in the high-level bits during transmission.

In general, the following methods are used to stably transmit wireless data: a method of using error correction coding to restore data; and a method of retransmitting data having an error from a transmitter to a receiver.

### SUMMARY OF THE INVENTION

The present invention provides a method and apparatus for applying different error correction coding processes to uncompressed data to be transmitted according to the significance of bits constituting the data.

In one aspect, different code rates are applied to uncompressed data according to the significance of bits or bit groups included in the uncompressed data when the uncompressed data is transmitted or received over a wireless network.

In another aspect, coding and decoding are performed in a mode set according to the size and number of bit groups.

According to an aspect of the present invention, there is provided an apparatus for transmitting uncompressed data, the apparatus including: a mode determining unit determining a mode corresponding to a condition; a grouping unit classifying bits of each pixel included in the uncompressed data into two or more groups according to the result of the determination; an error correction coding unit performing error correction coding on each of the groups at a code rate corresponding to the determined mode; and a radio frequency (RF) processing unit transmitting the coded uncompressed data.

According to another aspect of the present invention, there is provided an apparatus for receiving uncompressed data, the apparatus including: a mode determining unit determining a mode corresponding to a condition; an RF processing unit receiving coded uncompressed data that has two or more groups classified according to the determined mode; an error correction decoding unit performing error correction decoding on each of the groups at a code rate corresponding to the determined mode; and a bit assembler assembling the groups subjected to the error correction decoding to generate decoded uncompressed data.

According to still another aspect of the present invention, there is provided a method of transmitting uncompressed data, the method including: determining a mode corresponding to a condition; classifying bits of each pixel included in the uncompressed data into two or more groups according to the result of the determination; performing error correction coding on each of the groups at a code rate corresponding to the determined mode; and transmitting the coded uncompressed data.

According to yet another aspect of the present invention, there is provided a method of receiving uncompressed data, the method including: determining a mode corresponding to a condition; receiving coded uncompressed data that has two or more groups classified according to the determined mode; performing error correction decoding on each of the groups at a code rate corresponding to the determined mode; and assembling the groups subjected to the error correction decoding to generate decoded uncompressed data.

### BRIEF DESCRIPTION OF THE DRAWINGS

The above and other aspects will become more apparent by describing in detail exemplary embodiments thereof with reference to the attached drawings in which:

FIG. 1 is a diagram illustrating the comparison between the frequency band of the IEEE 802.11 standard and the frequency band of a millimeter wave;

FIG. 2 is a diagram illustrating one pixel component having a plurality of bit levels;

FIG. 3 is a diagram illustrating the structure of PPDU of the IEEE 802.11 a standard;

FIG. 4 is a diagram illustrating an error correction coding method according to the related art;

FIG. 5 is a diagram illustrating an error correction coding method according to an exemplary embodiment of the invention;

FIG. 6 is a block diagram illustrating the structure of a transmitting apparatus for transmitting uncompressed data according to an exemplary embodiment of the invention;

FIG. 7 is a block diagram illustrating the detailed structure of an error correction coding unit shown in FIG. 6 according to an exemplary embodiment of the invention;

FIG. 8 is a diagram illustrating an example of the structure of a convolution coding unit having a basic code rate of 1/2 according to an exemplary embodiment of the invention;

FIGS. 9A to 9C are diagrams illustrating a puncturing process performed at different code rates according to an exemplary embodiment of the invention;

FIGS. 10A to 10C are diagrams illustrating groups classified to have different sizes according to an exemplary embodiment of the invention;

FIG. 11 is a diagram illustrating a mode table according to an exemplary embodiment of the invention;

FIG. 12 is a block diagram illustrating the structure of a receiving apparatus for receiving uncompressed data according to an exemplary embodiment of the invention;

FIG. 13 is a block diagram illustrating the detailed structure of an error correction decoding unit shown in FIG. 11, according to an exemplary embodiment of the invention;

FIG. 14 is a flow chart illustrating a mode negotiating process performed by the transmitting apparatus according to an exemplary embodiment; and

FIG. 15 is a flow chart illustrating a mode negotiating process performed by the receiving apparatus according to an exemplary embodiment of the invention.

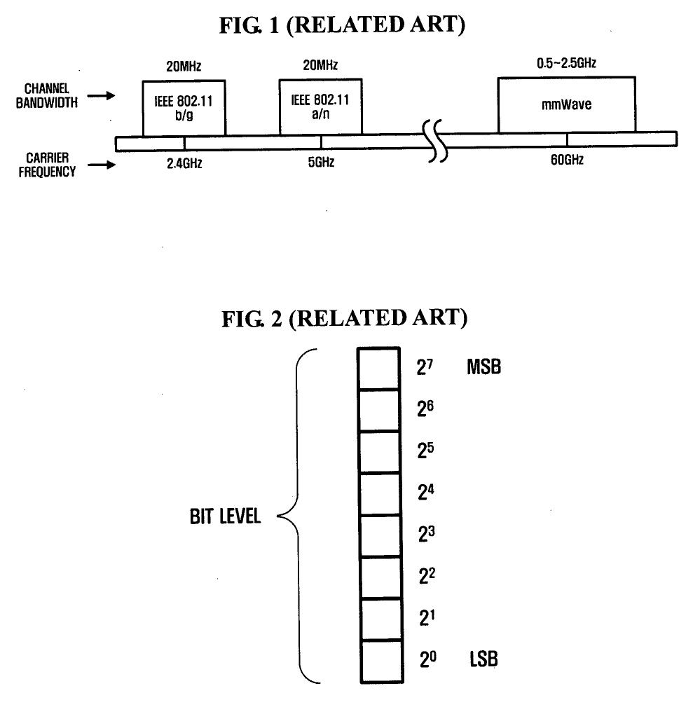

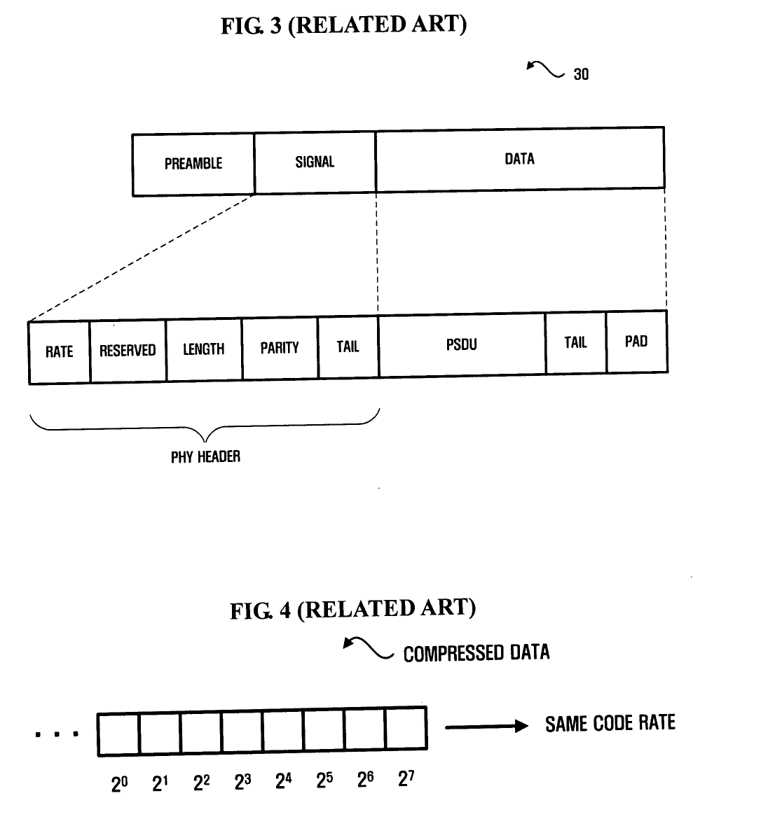

### DESCRIPTION OF THE EXEMPLARY EMBODIMENTS

Aspects and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will now be described more fully with reference to the accompanying drawings. In the exemplary embodiments, the term “unit” may refer to a hardware unit, a software unit, or a hybrid hardware-software unit, based on the understanding of one skilled in the art with respect to the particular unit. However, all of the units are understood to have a structure in the art.

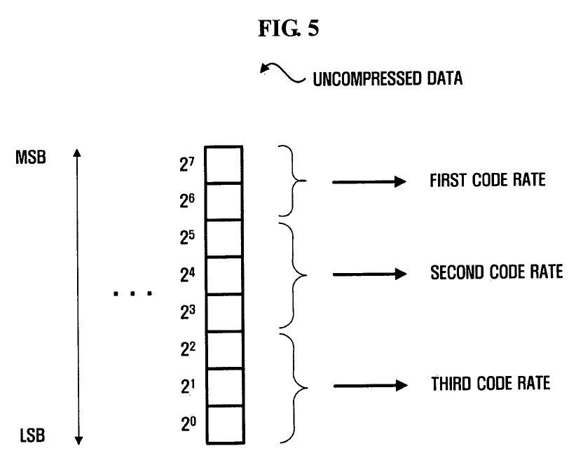

FIG. 4 is a diagram illustrating an error correction coding method according to the related art, and FIG. 5 is a diagram illustrating an error correction coding method according to an exemplary embodiment of the invention.

Compressed data is generated through processes for improving a compression rate, such as quantization and entropy coding, and thus there is no difference in significance between bits constituting each pixel that is included in the compressed data. Therefore, as shown in FIG. 4, error correction coding is generally performed on the related art compressed data at a fixed code rate. Even when error correction coding is performed on the compressed data at a variable code rate, the error correction coding is performed according to an external environment, such as a communication environment, rather than the significance of each data bit.

However, as described with reference to FIG. 2, in the compressed data, bits at different bit levels have different significances. Therefore, as shown in FIG. 5, a plurality of bits included in a pixel can be classified into groups of bits according to bit levels and error correction coding performed on the groups at different code rates.

Meanwhile, when different error correction processes are performed on all bits, the amounts of computation of a transmitting apparatus 600 and a receiving apparatus may increase. Therefore, the following method may be used: a plurality of bit levels are classified into several groups of bits, and error correction coding is performed on the classified groups at different code rates. In this case, a low code rate is applied to bits belonging to a group having relatively high significance. Therefore, in this exemplary embodiment, different code rates are applied according to the significance of data to improve the transmission efficiency of uncompressed data.

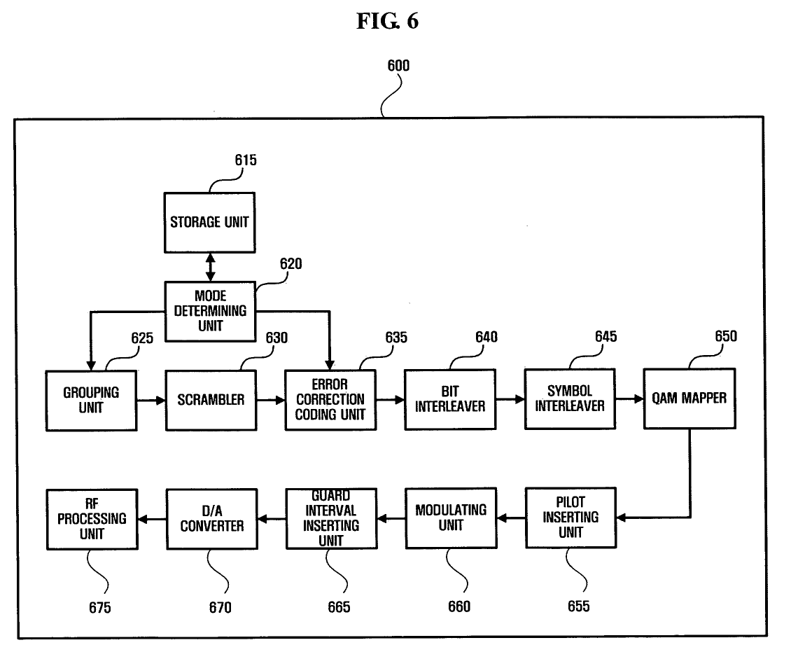

FIG. 6 is a block diagram illustrating the structure of a transmitting apparatus for transmitting uncompressed data according to an exemplary embodiment of the invention. The transmitting apparatus 600 includes a mode determining unit 620, a storage unit 615, a grouping unit 625, a scrambler 630, an error correction coding unit 635, a bit interleaver 640, a symbol interleaver 645, a quadrature amplitude modulation (QAM) mapper 650, a pilot inserting unit 655, a modulating unit 660, a guard interval inserting unit 665, a digital-to-analog (D/A) converter 670, and an RF processing unit 675.

The mode determining unit 620 determines a mode corresponding to a condition. The condition includes at least one of the frequency of occurrence of errors, the selection of a user, and the performance of an apparatus for receiving uncompressed data (hereinafter, referred to as a receiving apparatus).

The frequency of occurrence of errors may be detected by the receiving apparatus. The receiving apparatus receives uncompressed data from the transmitting apparatus 600 to detect the frequency of occurrence of errors and transmits the result to the transmitting apparatus 600, thereby changing a mode. For example, when errors occur frequently, the receiving apparatus selects a mode in which the ratio of low-level bits is high to reduce the frequency of occurrence of errors although the quality of an image is lowered. On the other hand, when the frequency of occurrence of errors is low, the receiving apparatus selects a mode in which the ratio of high-level bits is high. In addition, when the frequency of occurrence of errors is lower than a threshold value, the receiving apparatus may select an equal error protection coding mode.

Then, the receiving apparatus may determine a mode according to its own capability to reproduce uncompressed data, and allows the transmitting apparatus 600 to encode the uncompressed data in the determined mode and transmit the encoded uncompressed data. For example, when the receiving apparatus is a television capable of reproducing high-resolution images, a user can recognize a small error. Therefore, the receiving apparatus selects a mode in which the ratio of high-level bits is high. When the receiving apparatus is a portable apparatus capable of reproducing low-resolution images, the user can recognize only a large error. Therefore, the receiving apparatus selects a mode in which the ratio of low-level bits is high.

Further, the user of the transmitting apparatus 600 or the receiving apparatus may directly set a mode such that the uncompressed data is transmitted or received in the selected mode.

The mode determining unit 620 may negotiate with the receiving apparatus to determine the mode. For example, when the receiving apparatus determines the mode on the basis of the frequency of occurrence of errors, the selection of the user, or reproduction capability, the mode determining unit 620 may receive information thereon to determine the mode. When the user of the transmitting apparatus 600 sets the mode, the mode determining unit 620 transmits information thereon to the receiving apparatus through the RF processing unit 675.

The grouping unit 625 classifies bits of each pixel included in the uncompressed data into two or more groups according to the significance thereof on the basis of the result determined by the mode determining unit 620. That is, the grouping unit 625 classifies the bits into groups having a size and a number corresponding to the determined mode. For example, the grouping unit 625 may classify 8 bit levels into three groups, that is, first to third groups including two bit levels, three bit levels, and three bit levels from the highest bit level, respectively. Different code rates are applied to the classified groups. Alternatively, the grouping unit 625 may classify the bits into two groups, that is, a first group including four high bit levels and a second group including four low bit levels, or it may classify the bits into eight groups corresponding to eight bit levels.

The scrambler 630 scrambles input uncompressed data. The scrambling of data makes it possible to substantially prevent timing information between the transmitting apparatus 600 for transmitting signals and the receiving apparatus for receiving the signals from being lost and to evenly distribute energy of the uncompressed data over all bands. According to an exemplary embodiment, the scrambler 630 may use a generator polynomial P(x) as shown in the following Expression 1:

P(x)=x⁷+x⁴+1 [Expression 1]

When the generator polynomial P(x) represented by Expression 1 is used, the scrambler 630 may include a shift register having 7 unit registers and two adders. Each of the unit registers has an initial value of 1. Of course, the invention is not limited thereto, but the initial value allocated to the unit register may vary according to exemplary embodiments.

A scramble process is performed in a data unit, and the unit register is set to an initial value whenever the scramble process is performed in a new data unit. The generator polynomial used by the scrambler 630 and the structure of the scrambler 630 are limited to Expression 1 and the above-mentioned structure, but they may vary according to the exemplary embodiments.

The error correction coding unit 635 performs error correction coding on the bits classified by the grouping unit 625 at the code rate corresponding to the mode determined by the mode determining unit 620. In this case, the error correction coding unit 635 may apply the same code rate or different code rates to the groups according to the determined mode to perform the error correction coding on the groups.

The error correction coding may include at least one of convolution coding and block coding (for example, Reed-Solomon coding). When the error correction coding is the convolution coding, different code rates may be generated for groups by making a different number of bits eliminated from a plurality of bits included in each group. When the error correction coding is the block coding, the different code rates may be generated for the groups by setting the sizes of parity bytes for the groups to be different from each other. In the following description, the convolution coding may be mainly used as the error correction coding, but the invention is not limited thereto. For example but not by way of limitation, any of the block coding, low density parity check (LDPC) coding, Bose-Chaudhuri-Hocquenghem (BCH) coding, and Hamming coding may be used as the error correction coding.

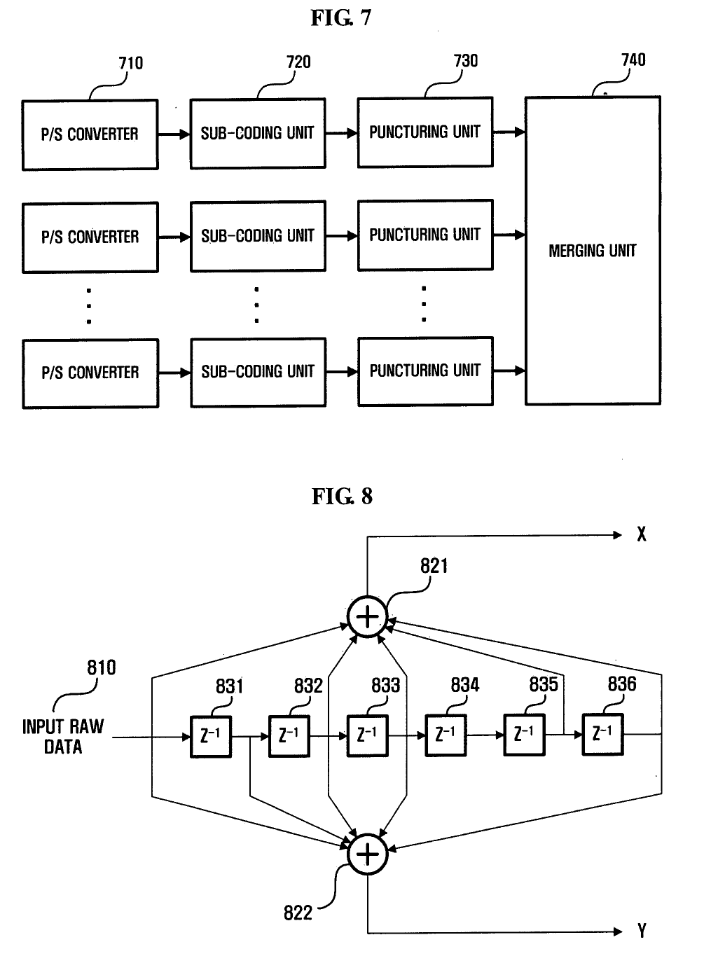

The error correction coding includes a process of converting an input k bit into an n-bit codeword. In this case, the code rate is represented by “k/n”. As the code rate becomes lower, the ratio of the bit of the converted codeword to the input bit is larger, which results in an increase in the efficiency of error correction. The error correction coding unit 635 will be described in detail below with reference to FIG. 7.

The bit interleaver 640 and the symbol interleaver 645 interleave the data encoded by the error correction coding unit 635. The block sizes of the bit interleaver 640 and the symbol interleaver 645 depend on the number of bits included in one orthogonal frequency division multiplexing (OFDM) symbol. The bit interleaver 640 and the symbol interleaver 645 disperse a bit sequence. However, the bit interleaver 640 performs interleaving in the unit of bits, but the symbol interleaver 645 performs interleaving in the unit of symbols. Adjacent bits of data input by the bit interleaver 640 and the symbol interleaver 645 may be mapped to different sub-carriers not adjacent to each other, and alternately mapped to the most significant bit and the least significant bit of a constellation.

When a burst error occurs in data processed by the bit interleaver 640 and the symbol interleaver 645 during transmission, the burst error may be changed to a random error by a de-interleaving operation of the receiving apparatus.

The QAM mapper 650 modulates the interleaved data by a QAM modulating method to perform a symbol mapping operation. Any of the following methods may be used as the QAM modulating method: quadrature phase shift keying (QPSK), 16 quadrature amplitude modulation (16QAM), and 64 quadrature amplitude modulation (64QAM).

The pilot inserting unit 655 inserts a pilot into input data. The pilot may be used for frequency synchronization, clock synchronization, and channel estimation.

The modulating unit 660 modulates the data having the pilot inserted thereinto. For example, a single carrier modulation method or an OFDM modulation method may be used as the modulation method. Hereinafter, the OFDM modulation method will be described below. In the OFDM modulation method, input data is classified into N parallel M-array data symbols, and the classified data symbols are modulated through corresponding sub-carrier waves. The results modulated through the sub-carrier waves are added to form one OFDM symbol. The sub-carrier waves are orthogonal to each other.

The guard interval inserting unit 665 inserts a guard interval into the data modulated by the OFDM system. The guard interval has a function of preventing the interference between symbols or the interference between carrier waves (ICI: inter-carrier interference). When the modulating unit 660 uses the single carrier modulation method, the guard interval inserting unit 665 may be removed from the transmitting apparatus 600.

The D/A converter 670 converts digital data having the guard interval inserted thereinto into analog data, and the RF processing unit 675 processes the analog data transmitted from the D/A converter 670 into an RF signal and transmits the RF signal through a communication channel. In this case, the communication channel includes a communication channel having a band of 60 GHz.

In this embodiment, the transmitting apparatus 600 shown in FIG. 6 is provided with one error correction coding unit 635, one modulating unit 660, and one D/A converting unit 670, but the invention is not limited thereto. For example but not by way of limitation, the transmitting apparatus 600 may further include a separate multiplexer and a separate demultiplexer and thus have a plurality of error correction coding units 635, a plurality of modulating units 660, and a plurality of D/A converters 670.

FIG. 7 is a block diagram illustrating the detailed structure of the error correction coding unit 635 shown in FIG. 6. The error correction coding unit 635 includes P/S (parallel/serial) converters 710, sub-coding units 720, puncturing units 730, and a merging unit 740.

The P/S converter 710 converts parallel data of a group according to the bit level into serial data in order for error correction coding. A plurality of P/S converters 710 may be provided so as to correspond to the number of groups. For example, when 8-bit data is classified into a high-level group composed of four bit levels and a low-level group composed of four bit levels, the first P/S converter converts parallel data at the top four bit levels into serial data, and the second P/S converter converts parallel data at the bottom four bit levels into serial data.

The sub-coding unit 720 performs error correction coding on the serial data transmitted from the P/S converter 710. A plurality of sub-coding units 720 may be provided so as to correspond to the number of groups. Each sub-coding unit 720 performs error correction coding at the code rate corresponding to the mode determined in the transmitted group. For example, the first sub-coding unit may apply a code rate of 1/3 to the top four bit level groups, and the second sub-coding unit may apply a code rate of 2/3 to the bottom four bit level groups to perform error correction coding. The code rate applied to the top four bit level groups is lower than the code rate applied to the bottom four bit level groups.

The error correction coding includes convolution coding and block coding. FIG. 8 is a diagram illustrating the structure of a convolution coding unit having a basic code rate of 1/2.

The convolution coding unit shown in FIG. 8 includes two adders 821 and 822 and six registers 831, 832, 833, 834, 835, and 836. Convolution coding unit includes a plurality of registers because a convolution coding algorithm compares previous data with the current data to perform coding. In general, the sum of the number of registers and the number of raw data that is input, that is, a value obtained by adding 1 to the number of registers is called a constraint length. That is, the convolution coding unit receives raw data 810 and outputs encoded data X and Y.

The puncturing unit 730 punctures some of the bits subjected to the error correction coding. The puncturing includes deleting some bits in order to increase the transmission rate of the bits encoded by the convolution coding unit. In the puncturing, some bits are not transmitted. The puncturing makes it possible to raise the transmission rate of the bits and thus to transmit a larger amount of data, as compared to when the puncturing is not performed, but the probability of the error occurring when the data is received may increase.

That is, when the convolution coding is performed as the error correction coding, different code rates are generated for groups of bits by making a different number of bits eliminated from a plurality of bits included in each group corresponding to the bit level.

The puncturing unit 730 performs puncturing on the data transmitted from the convolution coding unit. When the sub-coding unit 720 is a block coding unit, the puncturing unit 730 may be removed from the error correction coding unit 635.

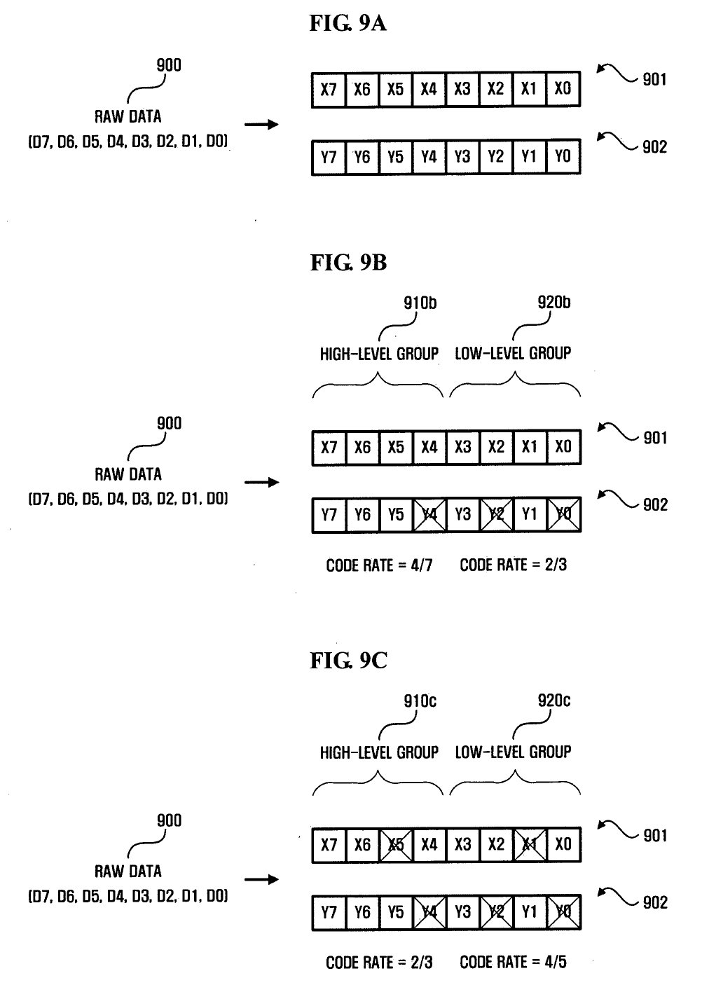

FIGS. 9A to 9C are diagrams illustrating a puncturing process performed at different code rates according to an exemplary embodiment of the invention. As shown in FIGS. 9A to 9C, the convolution coding unit having a basic cod rate of 1/2 converts bits separated according to levels or groups of bits into codewords X0 to X7 and Y0 to Y7 (901 and 902) that is twice the number of raw data D0 to D7 (900). In this exemplary embodiment, a high-level group and a low-level group each have four bits.

FIG. 9A shows a case in which the puncturing process is not performed. As shown in FIG. 9A, the input raw data D0 to D7 (900) are converted into the codewords X0 to X7 and Y0 to Y7 (901 and 902) so that the data is output with the basic code rate being maintained.

In FIG. 9B, the puncturing process is performed such that a code rate of 4/7 is applied to a high-level group 910b composed of the raw data D4 to D7 and a code rate of 2/3 is applied to a low-level group 920b composed of the raw data D0 to D3. In FIG. 9C, the puncturing process is performed such that a code rate of 2/3 is applied to a high-level group 910c composed of the raw data D4 to D7 and a code rate of 4/5 is applied to a low-level group 920c composed of the raw data D0 to D3.

Considering only the puncturing process, in FIG. 9A, the code rate is not applied at all. In FIG. 9B, a code rate of 8/13 is applied, and in FIG. 9C, a code rate of 8/11 is applied. That is, different code rates are applied to the same input data according to bit levels. The puncturing unit 730 applies different code rates to the high-level group and the low-level group on the basis of the determination of the mode determining unit to perform the puncturing process.

In FIGS. 9A to 9C, the high-level group and the low-level group each have four bits, but the invention is not limited thereto. As described above, the number of groups and the size thereof may be determined by the mode determining unit 620. Therefore, for example, the puncturing unit 730 may apply different code rates to a first group composed of one bit, a second group composed of three bits, and a third group composed of four bits in the order of bit levels to perform the puncturing process.

As described above, the puncturing unit 730 performs the puncturing process on the basis of the determination of the determining unit 620. In this case, the puncturing unit may receive the number of groups, the sizes of groups, and a code rate from the mode determining unit 620, or it may receive only a mode identifier from the mode determining unit 620. When receiving only the mode identifier, the puncturing unit 730 extracts the number of groups, the sizes of groups, and a code rate from a mode table 1100 previously stored and performs the puncturing process using them.

The transmitting apparatus 600 may be provided with a storage unit 615 for storing the mode table 1100. The storage unit 615 is a module capable of inputting/outputting information, such as a hard disk, a flash memory, a compact flash (CF) card, a secure digital (SD) card, a smart media (SM) card, a multimedia card (MMC), or a memory stick. The storage unit 615 may be provided in the transmitting apparatus 600, or it may be provided in a separate apparatus.

The merging unit 740 merges data in each bit level group to generate a payload, that is, a media access control (MAC) protocol data unit (MPDU).

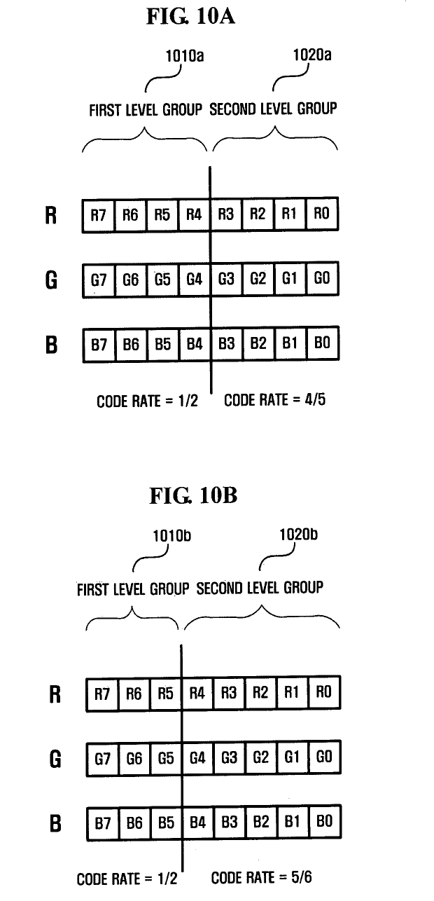

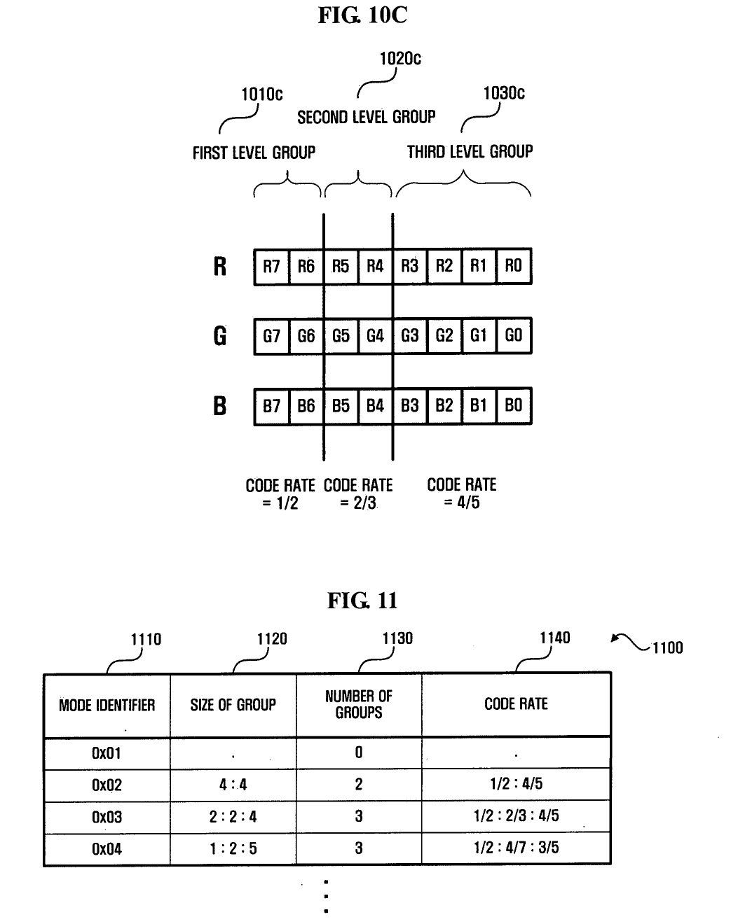

FIGS. 10A to 10C are diagrams illustrating groups classified to have different sizes according to an exemplary embodiment of the invention. In FIGS. 10A to 10C, a pixel includes three sub-pixels, that is, R, G, and B sub-pixels, and each sub-pixel is composed of 8 bits.

In FIG. 10A, a high bit level group 1010a and a low bit level group 1020a each have 4 bits. In FIG. 10B, a high bit level group 1010b and a low bit level group 1020b have 3 bits and 5 bits, respectively. In FIG. 10C, a first bit level group 1010c, a second bit level group 1020c, and a third bit level group 1030c from the highest bit level have 2 bits, 2 bits, and 4 bits, respectively.

In addition, different code rates may be applied to the groups, which is performed by the puncturing process of the puncturing unit 730.

FIG. 11 is a diagram illustrating a mode table according to an exemplary embodiment of the invention. The mode table 1100 includes a mode identifier field 1110, a group size field 1120, a group number field 1130, and a code rate field 1140.

An identifier of a code indicating a specific mode is input into the mode identifier field 1110. The transmitting apparatus 600 and the receiving apparatus may transmit and receive only the mode identifier to perform a mode negotiation. Therefore, the same mode table 1100 may be stored in the transmitting apparatus 600 and the receiving apparatus.

The sizes of groups classified according to bit levels are input into the group size field 1120, and the number of groups classified according to bit levels is input into the group number field 1130. For example, in case of FIG. 10A, 2 is input into the group number field 1130, and 4:4 is input into the group size field 1120. In case of FIG. 10C, 3 is input into the group number field 1130, and 2:2:4 is input into the group size field 1120.

A code rate for each group corresponding to the mode is input into the code rate field 1140. For example, when the number of groups is 2, two code rates of 1/2 and 4/5 may be input into the code rate field 1140. When the number of groups is 3, three code rates of 1/2, 2/3, and 4/5 may be input into the code rate field 1140.

FIG. 11 shows the mode table 1100 when the convolution coding is performed, but the invention is not limited thereto. For example, a mode table for block coding may be separately provided, or a mode table having various coding methods integrated therein may be provided. In this case, when the integrated mode table is provided, a field indicating a coding method may be additionally provided in the mode table.

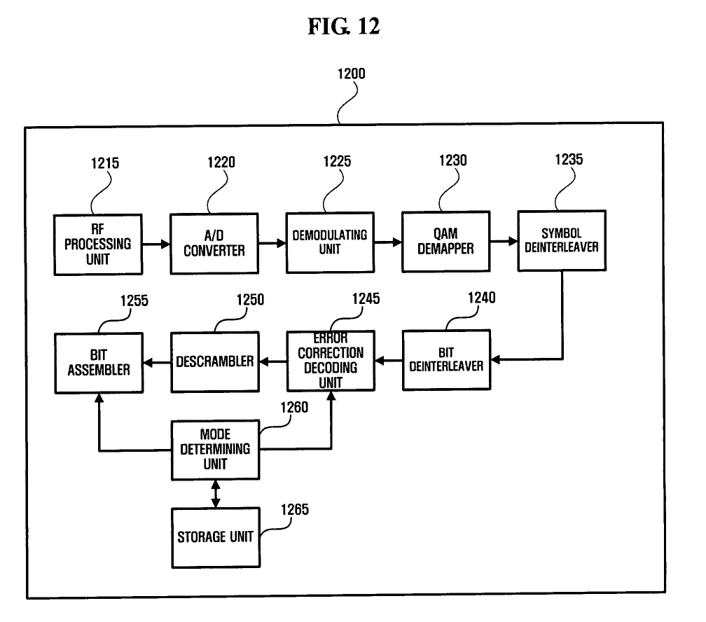

FIG. 12 is a block diagram illustrating the structure of a receiving apparatus 1200 for receiving uncompressed data according to an exemplary embodiment of the invention. The receiving apparatus 1200 includes a mode determining unit 1260, a storage unit 1265, an RF processing unit 1215, an analog-to-digital (A/D) converter 1220, a demodulator 1225, a QAM demapper 1230, a symbol deinterleaver 1235, a bit deinterleaver 1240, an error correction decoding unit 1245, a descrambler 1250, and a bit assembler 1255.

The mode determining unit 1260 determines a mode corresponding to a condition. The condition indicates the above-mentioned condition, and the mode determining unit 1260 negotiates with the transmitting apparatus 600 to determine the mode. In this case, the mode determining unit 1260 extracts the mode determined by the negotiation from the storage unit 1265 and supplies the extracted mode to the demodulator 1245.

The RF processing unit 1215 receives through a communication channel uncompressed data composed of a pixel including bits that are classified into two or more groups according to the mode determined by the mode determining unit 1260 and are then encoded. In this embodiment, the communication channel includes a communication channel of a 60 GHz band.

The A/D converter 1220 converts analog data transmitted from the RF processing unit 1215 into digital data.

The demodulator 1225 demodulates the digital data transmitted from the A/D converter 1220. The demodulation corresponds to the modulation by the transmitting apparatus 600, and the demodulation method may vary according to the modulation method of the transmitting apparatus 600. For example, when a single carrier modulation method is used, the demodulator 1225 performs single carrier demodulation. When an OFDM modulation method is used, the demodulator 1225 performs OFDM demodulation.

The QAM demapper 1230, the symbol deinterleaver 1235, and the bit deinterleaver 1240 perform operations corresponding to the QAM mapper 650, the symbol interleaver 645, and the bit interleaver 640 of the transmitting apparatus 600, respectively. Since the above-mentioned modules correspond to each other, a detailed description thereof will be omitted.

The error correction decoding unit 1245 applies the code rate corresponding to the mode determined by the mode determining unit 1260 to the groups of bit levels constituting the received uncompressed data to perform error correction decoding. In this case, the error correction decoding unit 1245 may apply the same code rate or different code rates to each group according to the determined mode to perform error correction coding.

The descrambler 1250 descrambles data transmitted from the error correction decoding unit 1245.

The bit assembler 1255 assembles the bits classified by level (from the highest level to the lowest level) that are output from the descrambler 1250 to restore each sub-pixel component, thereby generating demodulated uncompressed data. In this case, the bit assembler 1255 checks the number of groups and the sizes of groups on the basis of the mode transmitted from the mode determining unit 1260 and assembles the bits according to the check result.

Each sub-pixel component restored by the bit assembler 1255 is transmitted to a reproducing unit (not shown). Then, the reproducing unit collects each sub-pixel component, that is, pixel data to form a video frame and then displays the video frame on a display device (not shown), such as a cathode ray tube (CRT), an liquid crystal display (LCD), or a plasma display panel (PDP), in synchronization with a reproduction synchronization signal.

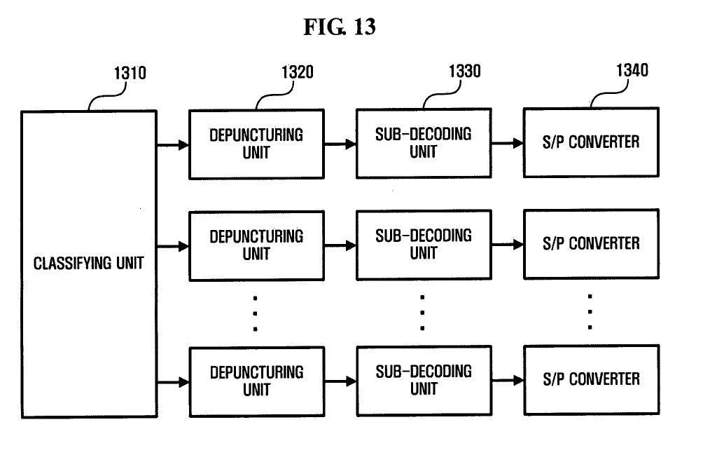

FIG. 13 is a block diagram illustrating the detailed structure of the error correction decoding unit 1245 shown in FIG. 12. The error correction decoding unit 1245 includes a classifying unit 1310, depuncturing units 1320, sub-decoding units 1330, and serial-to-parallel (S/P) converters 1340.

The classifying unit 1310 classifies received MPDU into groups of bit levels. The classified groups are transmitted to the depuncturing unit 1320.

The depuncturing unit 1320 generates bits omitted in the transmitted group and merges the generated bits with an input group. A plurality of depuncturing units 1320 may be provided so as to correspond to the number of groups classified by the classifying unit 1310.

The sub-decoding unit 1330 performs error correction decoding on the group transmitted from the depuncturing unit 1320. A plurality of sub-decoding un its 1330 may be provided so as to correspond to the number of groups.

The depuncturing unit 1320 and the sub-decoding unit 1330 may generate omitted bits with reference to the mode table 1100 stored in the storage unit 1265, or they may apply a specific code rate to perform error correction decoding.

The decoded data is transmitted to the S/P converter 1340, and the S/P converter 1340 converts decoded serial data into parallel data.

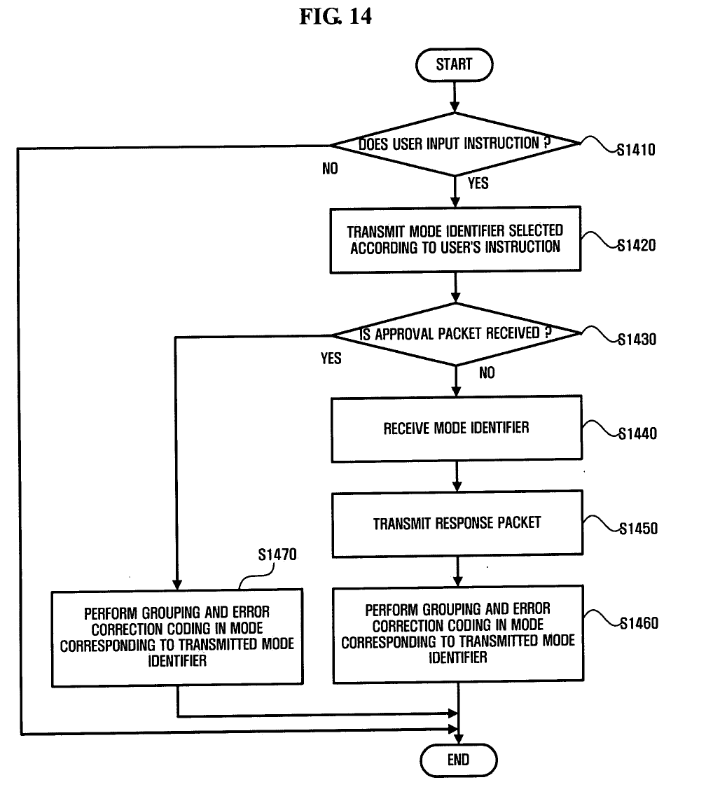

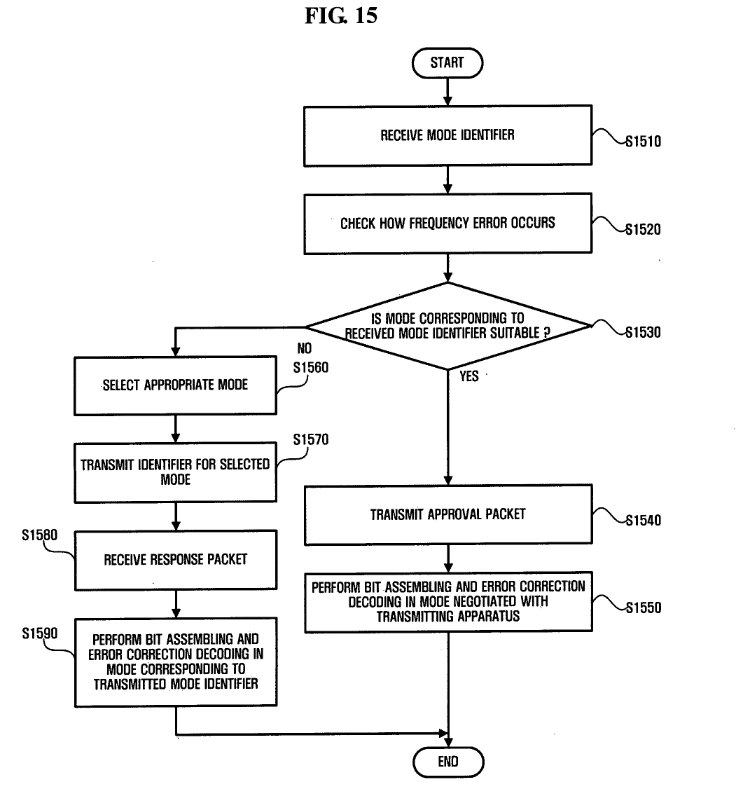

FIGS. 14 and 15 are flow charts illustrating a mode negotiating process performed between the transmitting apparatus 600 and the receiving apparatus 1200 according to an exemplary embodiment.

To transmit uncompressed data, the mode determining unit 620 of the transmitting apparatus 600 checks whether a user inputs an instruction to select a mode (operation S1410). When it is determined whether the user has input the instruction to select a specific mode, an identifier of the selected mode is transmitted to the receiving apparatus 1200 (operation S1420).

Then, the receiving apparatus 1200 receives the mode identifier (operation S1510), and the mode determining unit 1260 checks how frequently an error occurs in data being currently received (operation S1520). The data being currently received may be uncompressed data received from the transmitting apparatus 600 having transmitted the mode identifier, or it may be data received from a separate station.

Then, it is determined whether a mode corresponding to the received mode identifier is suitable for error correction decoding on the basis of the frequency of occurrence of the error (operation S1530). When it is determined that that mode is suitable for the error correction decoding, the mode determining unit 1260 of the receiving apparatus 1200 transmits to the transmitting apparatus 600 an approval packet indicating that the mode is determined (operation S1540).

The transmitting apparatus 600 checks whether the approval packet is received (operation S1430). When it is determined that the approval packet has been received, the transmitting apparatus 600 performs grouping and error correction coding in a mode corresponding to the transmitted mode identifier (operation S1470), and the receiving apparatus 1200 performs bit assembling and error correction decoding in the mode negotiated with the transmitting apparatus (operation S1550).

However, when the mode determining unit 1260 of the receiving apparatus 1200 determines' that error correction decoding is not to be performed in a mode corresponding to the received mode identifier, the mode determining unit 1260 selects an appropriate mode with reference to the mode table 1100 previously stored (operation S1560). For example, when the frequency of occurrence of errors is high, the mode determining unit 1260 of the receiving apparatus 1200 selects a mode in which a group of high-level bits is set to a small size. On the other hand, when the frequency of occurrence of errors is low, the mode determining unit 1260 selects a mode in which a group of high-level bits is set to a large size. When the frequency of occurrence of errors is lower than a threshold value, the mode determining unit 1260 of the receiving apparatus 1200 may select a mode in which the groups are classified and the code rate is not applied. The mode determining unit 1260 of the receiving apparatus 1200 transmits an identifier for the selected mode to the transmitting apparatus 600 (operation S1570).

Then, the transmitting apparatus 600 receives the mode identifier from the receiving apparatus 1200 (operation S1440). The mode determining unit 620 checks that the transmitted mode is rejected, sends the received mode to the grouping unit 625 and the error correction coding unit 635, and transmits to the receiving apparatus 1200 a response packet indicating that the error correction coding will be performed in the mode (operation S1450). The grouping unit 625 and the error correction coding unit 635 perform grouping and error correction coding in the received mode, respectively (operation S1460).

The mode determining unit 1260 of the receiving apparatus 1200 having received the response packet (operation S1580) allows the error correction decoding unit 1245 to perform bit assembling and error correction decoding in the mode (operation S1590).

Although the present invention has been described in connection with the exemplary embodiments, it will be apparent to those skilled in the art that various modifications and changes may be made thereto without departing from the scope and spirit of the invention. Therefore, it should be understood that the above embodiments are not limitative, but illustrative in all aspects.

According to the apparatus and method for transmitting/receiving uncompressed data of the invention, the following effects may be obtained.

First, when uncompressed data is transmitted or received over a wireless network, different code rates are applied to the data according to the significance of bits or bit groups included in the data, which makes it possible to stably transmit data and to improve transmission efficiency.

Second, coding and decoding are performed in a mode set according to the sizes and number of bit groups, so that an appropriate mode is applied according to the type of data, which makes it possible to improve the transmission efficiency of data.

What is claimed is:

1. An apparatus for transmitting uncompressed data, the apparatus comprising:
a mode determining unit which determines a mode corresponding to a condition;
a grouping unit which classifies bits of each pixel included in the uncompressed data into at least two groups according to the mode determined by the mode determining unit;
an error correction coding unit which performs error correction coding on each of the groups at a code rate corresponding to the mode determined by the mode determining unit; and
a radio frequency (RF) processing unit which transmits the uncompressed data which has been subjected to the error correction coding by the error correction coding unit.

2. The apparatus of claim 1, wherein the grouping unit generates groups having a size and a number corresponding to the mode determined by the mode determining unit.

3. The apparatus of claim 1, wherein the condition comprises at least one of a frequency of occurrence of errors, a selection of a user, and a performance of an apparatus for receiving the uncompressed data.

4. The apparatus of claim 1, wherein the mode determining unit negotiates with an apparatus for receiving the uncompressed data to determine the mode.

5. The apparatus of claim 1, wherein the bits are classified according to bit levels of the bits included in the groups.

6. The apparatus of claim 1, wherein the error correction coding unit performs the error correction coding by applying a same code rate or different code rates to the groups according to the mode determined by the mode determining unit.

7. The apparatus of claim 1, wherein the error correction coding comprises at least one of convolution coding and block coding.

8. The apparatus of claim 7, wherein when the error correction coding is the convolution coding, different code rates are generated for the groups by eliminating a different number of bits from a plurality of bits included in each group.

9. The apparatus of claim 7, wherein, when the error correction coding is the block coding, different code rates are generated for the groups by making sizes of parity bytes for the groups different from each other.

10. The apparatus of claim 1, wherein the RF processing unit transmits the uncompressed data which has been subjected to the error correction coding through a communication channel of a 60 GHz band.

11. An apparatus for receiving uncompressed data, the apparatus comprising:
a mode determining unit which determines a mode corresponding to a condition;
a radio frequency (RF) processing unit which receives coded uncompressed data that has at least two groups classified according to the mode determined by the mode determining unit;
an error correction decoding unit which performs error correction decoding on each of the groups at a code rate corresponding to the mode determined by the mode determining unit; and
a bit assembler that assembles the groups which have been subjected to the error correction decoding to generate decoded uncompressed data.

12. The apparatus of claim 11, wherein a size and a number of the classified groups correspond to the mode determined by the mode determining unit.

13. The apparatus of claim 11, wherein the condition comprises at least one of a frequency of occurrence of errors, a selection of a user, and a capability to reproduce the decoded uncompressed data.

14. The apparatus of claim 11, wherein the mode determining unit negotiates with an apparatus for transmitting the uncompressed data to determine the mode.

15. The apparatus of claim 11, wherein the classifying of the uncompressed data is performed according to bit levels of bits included in the groups.

16. The apparatus of claim 11, wherein the error correction decoding unit performs the error correction decoding by applying a same code rate or different code rates to the groups according to the mode determined by the mode determining unit.

17. The apparatus of claim 11, wherein the RF processing unit receives the coded uncompressed data through a communication channel of a 60 GHz band.

18. A method of transmitting uncompressed data, the method comprising:
determining a mode corresponding to a condition;
classifying bits of each pixel included in the uncompressed data into at least two groups according to a result of the determining;
performing error correction coding on each of the groups at a code rate corresponding to the mode; and
transmitting the uncompressed data which has been subjected to the error correction coding.

19. The method of claim 18, wherein the classifying of the bits comprises forming groups having a size and a number correspond to the mode.

20. The method of claim 18, wherein the condition comprises at least one of a frequency of occurrence of errors, a selection of a user, and a performance of an apparatus for receiving the uncompressed data.

21. The method of claim 18, wherein the determining of the mode comprises negotiating with an apparatus for receiving the uncompressed data to determine the mode.

22. The method of claim 18, the classifying of the bits is performed according to bit levels of the bits included in the groups.

23. The method of claim 18, wherein the performing of the error correction coding comprises applying one of the same code rate and different code rates to the groups according to the determined mode.

24. The method of claim 18, wherein the error correction coding comprises at least one of convolution coding and block coding.

25. The method of claim 24, wherein when the error correction coding is the convolution coding, different code rates are generated for the groups by making a different number of bits eliminated from a plurality of bits included in each group.

26. The method of claim 24, wherein, when the error correction coding is the block coding, different code rates are generated for the groups by making sizes of parity bytes for the groups different from each other.

27. The method of claim 18, wherein the transmitting of the uncompressed data comprises transmitting the uncompressed data subjected to the error correction coding through a communication channel of a 60 GHz band.

28. A method of receiving uncompressed data, the method comprising:
determining a mode corresponding to a condition;
receiving coded uncompressed data that has at least two groups classified according to the mode;
performing error correction decoding on each of the groups at a code rate corresponding to the mode; and
assembling the groups subjected to the error correction decoding to generate decoded uncompressed data.

29. The method of claim 28, wherein a size and a number of the classified groups correspond to the determined mode.

30. The method of claim 28, wherein the condition comprises at least one of a frequency of occurrence of errors, a selection of a user, and a capability to reproduce the decoded uncompressed data.

31. The method of claim 28, wherein the determining of the mode comprises negotiating with an apparatus for transmitting the uncompressed data to determine the mode.

32. The method of claim 28, wherein the classifying of the uncompressed data is performed according to the levels of bits included in the groups.

33. The method of claim 28, wherein the performing of the error correction decoding comprises applying a same code rate or different code rates to the groups according to the mode.

34. The method of claim 28, wherein the receiving of the coded uncompressed data comprises receiving the coded uncompressed data through a communication channel of a 60 GHz band.
